(19) United States
(12) Patent Application Publication
(10) Pub. No.: US 2003/0169731 A1
(43) Pub. Date: Sep. 11, 2003

(54) Crossbar switch with data suspension

(76) Inventor: John Alan Wickeraad, Granite Bay, CA (US)

Correspondence Address: HEWLETT-PACKARD COMPANY, Intellectual Property Administration, P.O. Box 272400, Fort Collins, CO, 80527-2400, US

(21) Appl. No.: 10/094,367

(22) Filed: Mar. 8, 2002

(51) Int. Cl. H04L 12/50

(52) U.S. Cl. 370/359; 370/386; 370/360

(57) ABSTRACT

One embodiment relates to a method of switching by a crossbar switch having a plurality of ports. The method includes transmitting data from a transmit port to a first receive port across the crossbar switch, receiving a control message at the transmit port to be sent to a second receive port, suspending the data transmission from the transmit port to the first receive port, transmitting the control message from the transmit port to the second receive port, and resuming the data transmission from the transmit port to the first receive port. Another embodiment relates to a crossbar switching system. The system includes circuitry at a transmit port for providing a data transfer mode and a data suspension mode.

### BACKGROUND OF THE INVENTION

1. Field of the Invention

The present invention relates generally to communications networks and electronic systems. More particularly, the invention relates to crossbar switching.

2. Description of the Background Art

A typical electronic crossbar switch includes a set of N ports, a switch array interconnecting the ports, and a static random access memory (SRAM). The switch array is made up of N buses and a N sets of multiplexers (or pass transistors). Each bus is hard-wired to a separate one of the transmit ports while the multiplexers allow the recieve ports to be coupled to any one of buses, such that any transmit port may be interconnected to a recieve port by controlling the multiplexer properly. Each reciever port has its own set of multiplexers so that each reciever port can independantly recieve from a transmit port. Each multiplexer may be controlled by an arbitration state machine (or a separate bit stored in the SRAM). The crossbar switch can route a signal from a transmit port to a receive port by turning on the appropriate multiplexer. A crossbar switch can be used for bus switching, data path routing and packet switching networks.

Latency is a general problem with crossbar switches. Typically, as more ports are required, the latency to switch a signal through the crossbar switch increases. Moreover, some current systems group data packets into large transfers. While such large transfers may be efficient in sending groups of data packets, they are disadvantageous in that the latency may at times be rather long for transferring control messages over the same crossbar switch. For example, such large transfers may use hundreds of cycles to transfer data, and the control messages may have to wait accordingly.

Another problem is that with increasing number of ports, it becomes more and more difficult to route the necessary circuits in the crossbar switch area. Timing for the signals in the circuits also becomes more challenging.

### BRIEF DESCRIPTION OF THE DRAWINGS

Non-limiting and non-exhaustive embodiments of the present invention are described in the Figures, in which:

FIG. 1 is a diagram depicting a system configuration in accordance with an embodiment of the invention;

FIG. 2 is a schematic diagram depicting the communications between the crossbar switching fabric and the nodes/CPU in accordance with an embodiment of the invention;

FIG. 3 depicts a flow chart of a method of switching by a crossbar switch in accordance with an embodiment of the invention;

FIG. 4 includes timing diagrams depicting the transmissions (to the crossbar) from a couple of transmit ports in accordance with an embodiment of the invention;

FIG. 5A depicts a transmit port for a crossbar switch in accordance with an embodiment of the invention; and

FIG. 5B depicts a receive port for a crossbar switch in accordance with an embodiment of the invention.

### SUMMARY

One embodiment of the invention relates to a method of switching by a crossbar switch having a plurality of ports. The method includes transmitting data from a first port to a second port across the crossbar switch, receiving a control message at the first port to be sent to a third port, suspending the data transmission from the first port to the second port, transmitting the control message from the first port to the third port, and resuming the data transmission from the first port to the second port.

Another embodiment of the invention relates to a crossbar switching system. The system includes circuitry at a transmit port for providing a data transfer mode and a data suspension mode.

### DETAILED DESCRIPTION

What is needed is further improvement to crossbar switching systems. The present invention identifies some causes of the above-mentioned problems in the Description of the Background Art and gives a design solution to reduce those problems with only relatively minor impact to switching performance.

One type of conventional crossbar switch includes both primary crossbar circuitry to switch data signals between the ports and secondary crossbar circuitry to switch control messages between the ports. The data signals include the actual data packets being switched between one port to another port, while the control messages may include, for example, request and reply messages between ports. Such request and reply messages may be used to determine when a data packet is allowed to be switched over the main crossbar. Advantageously, such a system switches both data and control messages with relatively low latency. Unfortunately, this type of system tends to suffer the circuit routing difficulties and signal timing challenges mentioned above. This is because both the data crossbar circuitry and control crossbar circuitry must be placed within the available semiconductor area.

Another type of conventional crossbar switch includes a single crossbar circuitry to switch both the data and control messages between ports. Advantageously, such a crossbar switch has fewer problems with circuit routing and signal timing. This is because it uses the single crossbar circuitry for both data and control messages and is easier to fit within the available semiconductor area. However, this type of system tends to suffer from increased latencies due to large data transfers and hence reduced switching performance.

The design provided by the present invention makes a relatively minor compromise on switching performance while avoiding circuit routing and signal timing difficulties. This is done by an improved method for dealing with both data and control messages being switched on a same crossbar circuitry. In particular, the method involves a data suspension mode where the transfer of data is temporarily suspended to allow control messages to be switched over the crossbar. Once the control messages have been transmitted, the data suspension mode is lifted, and data transfer may resume.

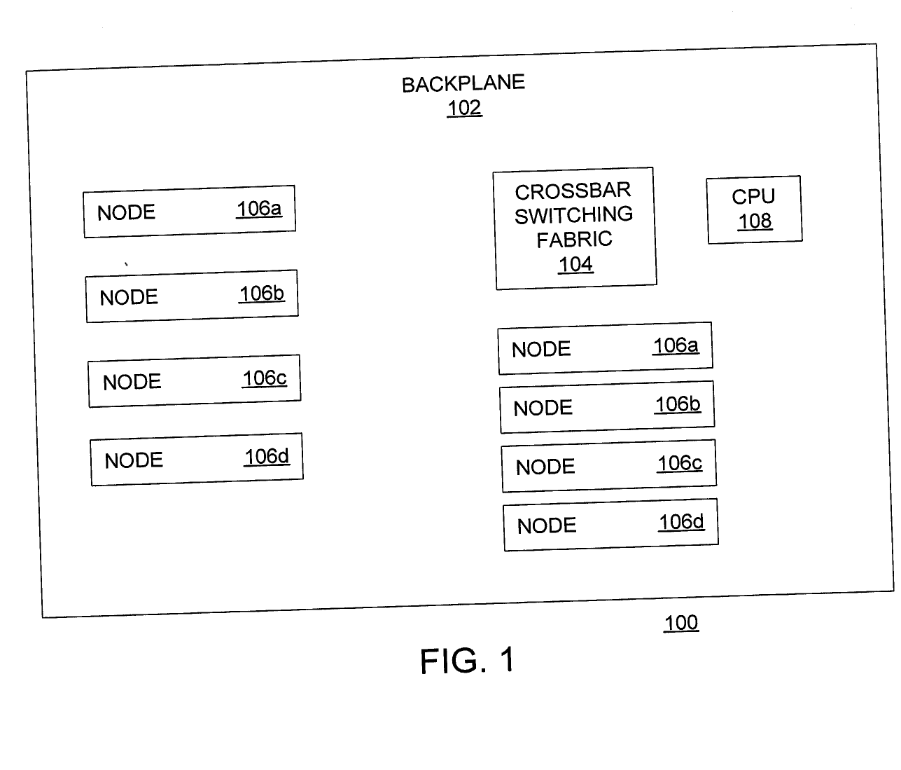

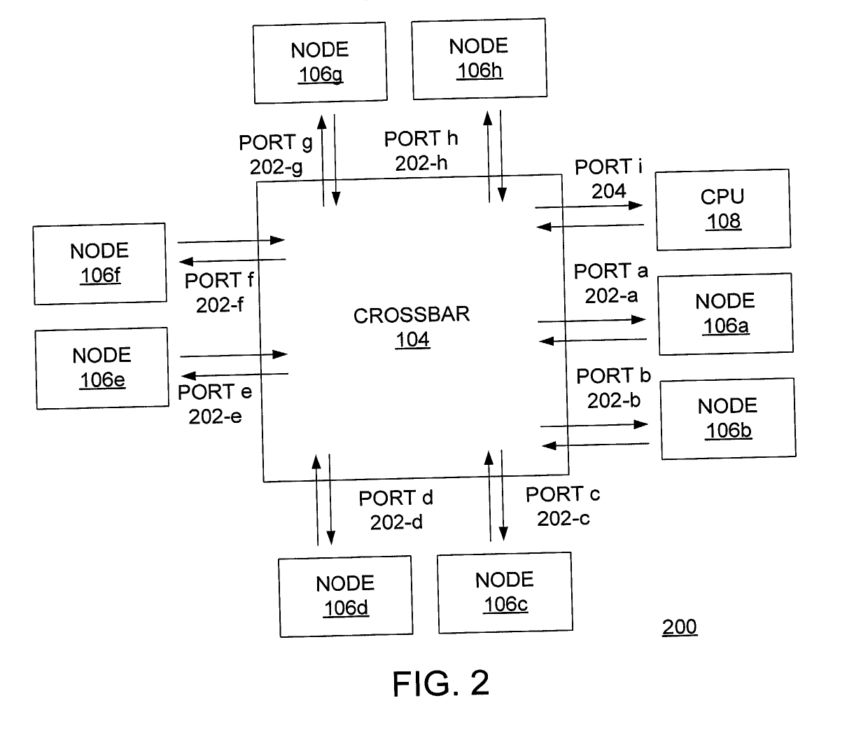

FIG. 1 is a diagram depicting a system configuration 100 in accordance with an embodiment of the invention. The following description of FIG. 1 may be understood in reference to FIG. 2. As illustrated in FIG. 1, the system configuration 100 includes a backplane 102, a crossbar switching fabric 104, a plurality of nodes 106a-h, and a CPU 108.

In one specific embodiment, the system may be configured on a backplane 102. Non-backplane configurations are, of course, possible. The nodes 106a-h may be implemented as cards that plug into slots in the backplane 102. The nodes 106a-h may be coupled to the crossbar switching fabric 104 by way of pairs of unidirectional high-speed differential links 202a-h. For instance, each pair of unidirectional high-speed link 202n may comprise eight differential pairs, each differential pair operating at 1.3 GHz for approximately 10 Gigabits of bandwidth per node. Each node 106n may include, for instance, up to twenty-four (24) Ethernet 10/100 ports. The CPU 108 may be a microprocessor coupled to the crossbar switching fabric 104 by way of another pair of unidirectional links 204 (for example, a PCI bus). The crossbar switching fabric 104 may have nine transmit/receive (TX/RX) ports (202a-h and 204) to link to the nodes 106a-h and to the CPU 108. Of course, other implementations of the switching fabric, links, nodes, and CPU are possible.

FIG. 2 is a schematic diagram depicting the communications between the crossbar switching fabric 104 and the nodes/CPU 106a-h/108 in accordance with an embodiment of the invention. In this embodiment, the nodes 106a-h are coupled to the crossbar switch 104 by way of the unidirectional link pairs 202a-h, respectively, to transmit/receive (TX/RX) ports a-h of the switch 104. The CPU 108 is coupled to the crossbar switch 104 via the separate unidirectional link pair 204 to TX/RX port i of the switch 104.

In one embodiment, the crossbar switch 104 may be implemented with distributed contention control. In an alternate embodiment, the contention control may be central. Contention control is needed when multiple transmit ports request the same receive port at the same time interval.

The specific configuration depicted in FIGS. 1 and 2 relate to a wiring closet level Ethernet switch for a business enterprise. Of course, other system configurations are contemplated to be within the scope of the claimed invention. The number of nodes may vary and so on. The specific system configuration depicted in FIGS. 1 and 2 represents merely one specific implementation of the invention.

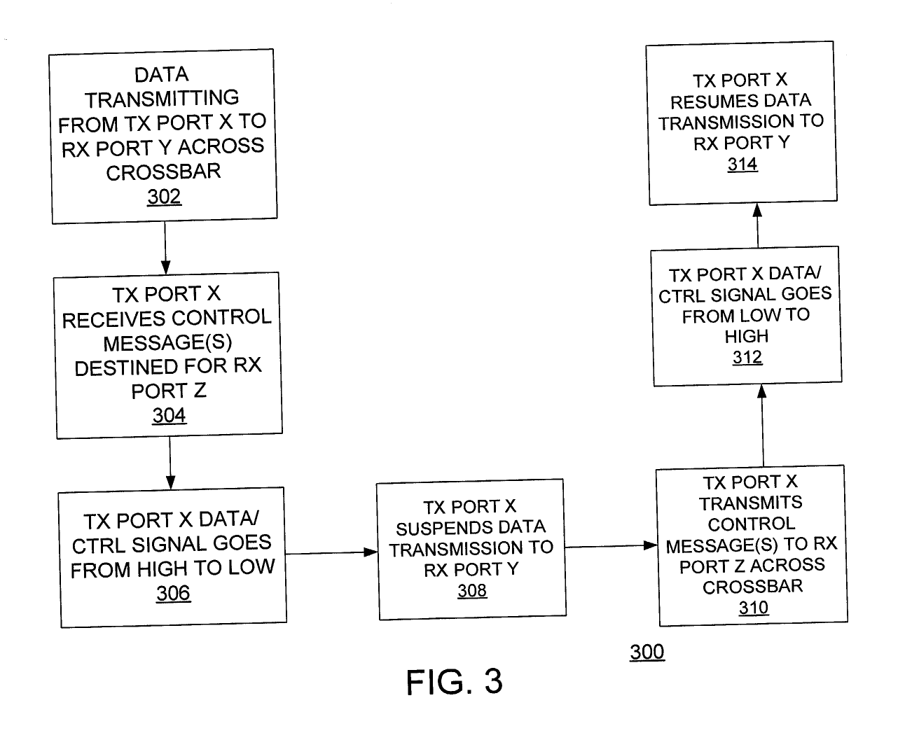

FIG. 3 depicts a flow chart of a method 300 of switching by a crossbar switch in accordance with an embodiment of the invention. As depicted in FIG. 3, the method 300 includes seven steps (302, 304, 306, 308, 310, 312, and 314).

The first step 302 represents the state where data is being transmitted across the crossbar switch 104 from a transmit port (“TX Port X”) to a first receive port (“RX Port Y”). Both the transmit and the receive ports may typically be from any of the TX/RX ports a through i. (In some embodiments, a data transfer may occur across the crossbar from a transmit port to a receive port on the same node). Here, the TX port X is set in data transfer mode.

In a second step 304, the TX port X receives one or more control message(s) destined for a second receive port (“RX Port Z”). RX Port Z may be any of the RX ports a-i. (RX port Z may be different from, or the same as, RX Port Y.) In accordance with an embodiment of the invention, such control messages are of higher priority to switch than data packets. For example, the control messages may include request, acknowledgment, and no-acknowledgment messages. A request message may be sent from TX Port X to RX Port Z to ask RX Port Z whether it is able and ready to accept data packets from TX Port X. On the other hand, an acknowledgment or no-acknowledgment message may be sent from TX Port X to RX Port Z in response to a prior request message from TX Port Z (paired with RX Port Z) to RX Port X (paired with TX Port X). An acknowledgment message may indicate that RX Port X is ready to accept data packets from TX Port Z, while a no-acknowledgment message may indicate that RX Port X is not ready at this time to receive the data packets from TX Port Z (for example, because receiving buffers for RX Port X are full or backlogged).

In a third step 306, a data/control (data/ctrl) signal may be affected by the pending control message(s) in the prior step 304. The pending control message(s) may cause the data/ctrl signal to transition, for example, from high to low (or vice-versa). This transition indicates to TX Port X that it is to change from the data transfer mode of the first step 302 to a data suspension mode.

In a fourth step 308, the TX Port X transitions to the data suspension mode and so suspends the data transfer from TX Port X to RX Port Y. Instead of data transfer, this mode provides for transfer of higher priority control messages while the data transfer is suspended.

In a fifth step 310, one or more control message(s) are sent from TX Port X to RX Port Z. For example, the control message(s) may include a request message, an acknowledgment message, and/or a non-acknowledgment message. Of course, other control messages may also be sent from TX Port X while in the data suspension mode. Furthermore, control messages may be sent from TX Port X to more than one receiving port (for example, first to one receiving port, then to a next receiving port) while in the data suspension mode.

In a sixth step 312, the data/control signal does a reverse transition and goes, for example, from low back to high (or vice-versa). This reverse transition indicates to port x that it is to exit from the data suspension mode and enter back into the data transfer mode.

Finally, in a seventh step 314, the port x exits from the data suspension mode re-enters the data transfer mode. Back in the data transfer mode, port x may resume transmitting the data packets to port y. Port x may continue to be in data transfer mode (for example, transmitting data packets to various receiving ports) until the data/control signal makes another transition as described above in relation to the third step 306.

Note that each transmit port may be in either data transfer mode or data suspension mode without affecting the modes that the other transmit ports are in. For instance, at a particular timeslot, TX port a and TX port c may be in data suspension mode, while the other TX ports (b, d, e, f, g, h, and i) may be in data transfer mode. Hence, the data suspension mode as described above is port-specific in that the mode is specific to a transmit port; each transmit port may be independently in either data transfer mode or data suspension mode.

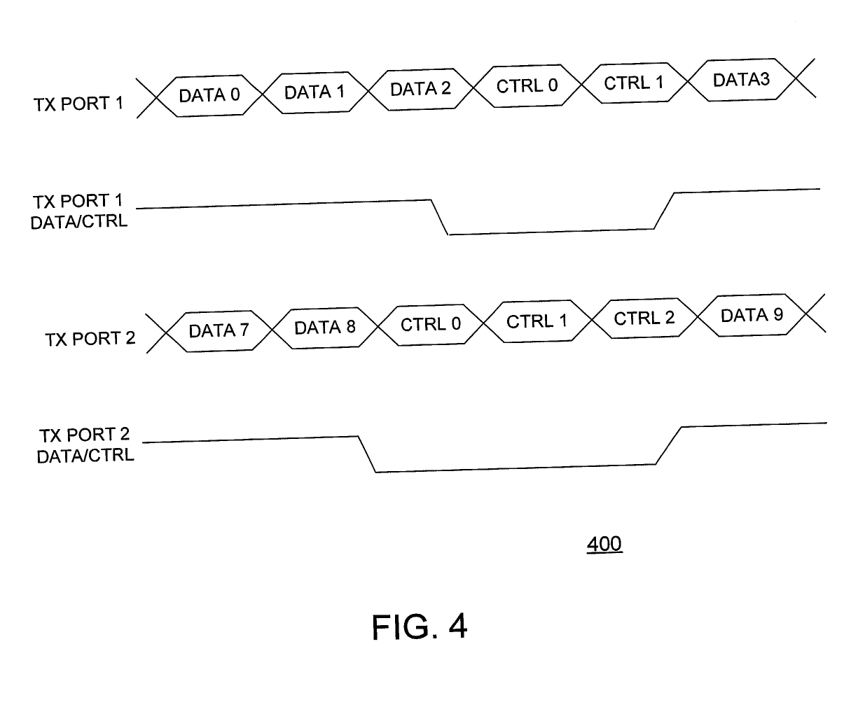

FIG. 4 includes timing diagrams 400 depicting the transmissions (to the crossbar) from a couple of transmit ports in accordance with an embodiment of the invention. At the top portion of FIG. 4, the TX Port 1 transmission (to the crossbar) and the TX Port 1 data/control (data/ctrl) signal are depicted. At the bottom portion of FIG. 4, the TX Port 2 transmission (to the crossbar) and the TX Port 2 data/control (data/ctrl) signal are depicted. (For example purposes, the transmit ports are labeled “TX Port 1” and “TX Port 2”, but they may refer to any of the crossbar ports configured to have data transfer and data suspension modes.)

As illustrated, TX Port 1 begins in data transfer mode with data/control signal in a high position and with data0, data1, and data2 being sent in the first three cycles. These data may be transmitted, for example purposes, to “RX Port 5”. However, prior to data3 being sent, the data/control signal for TX Port 1 transitions from high to low. This transition indicates that one or more control messages await sending from TX Port 1. The transition in data/ctrl causes TX Port 1 to enter into the data suspension mode for the subsequent cycle. In the data suspension mode, control messages are set instead of data packets. The hypothetical example illustrated in FIG. 4 shows the next two cycles being used to sent CTRL0 and CTRL1. These control messages may be sent, for example purposes, to “RX Port 3”. In this example, CTRL1 is the last control message pending. Hence, prior to the end of the CTRL1 cycle, the data/ctrl signal for TX Port 1 returns from low back to high. This transition causes TX Port 1 to exit the data suspension mode and re-enter the data transfer mode for the subsequent cycle. Hence, the data transfer resumes with the next pending data packet (DATA3) being transmitted to RX Port 5. TX Port 1 remains in the data transfer mode while the data/control for TX Port 1 remains high. In the data transfer mode, data packets may be sent to more than one receive port (e.g., to other ports besides RX Port 5). The same goes for the data suspension mode where control messages may be sent to more than one receive port (e.g., to other ports besides RX Port 3).

Similarly, as illustrated, TX Port 2 begins in data transfer mode with data/control signal in a high position and with data7 and data8 being sent in the first two cycles. These data may be transmitted, for example purposes, to “RX Port 6”. However, prior to data8 being sent, the data/control signal for TX Port 2 transitions from high to low. This transition indicates that one or more control messages await sending from TX Port 2. The transition in data/ctrl causes TX Port 2 to enter into the data suspension mode for the subsequent cycle. In the data suspension mode, control messages are set instead of data packets. The hypothetical example illustrated in FIG. 4 shows the next three cycles being used to sent CTRL0, CTRL1, and CTRL2. These control messages may be sent, for example purposes, to “RX Port 8”. In this example, CTRL2 is the last control message pending. Hence, prior to the end of the CTRL2 cycle, the data/ctrl signal for TX Port 2 returns from low back to high. This transition causes TX Port 2 to exit the data suspension mode and re-enter the data transfer mode for the subsequent cycle. Hence, the data transfer resumes with the next pending data packet (DATA9) being transmitted to RX Port 6. TX Port 2 remains in the data transfer mode while the data/control for TX Port 2 remains high. In the data transfer mode, data packets may be sent to more than one port (e.g., to other receive ports besides RX Port 6). The same goes for the data suspension mode where control messages may be sent to more than one receive port (e.g., to other ports besides RX Port 8).

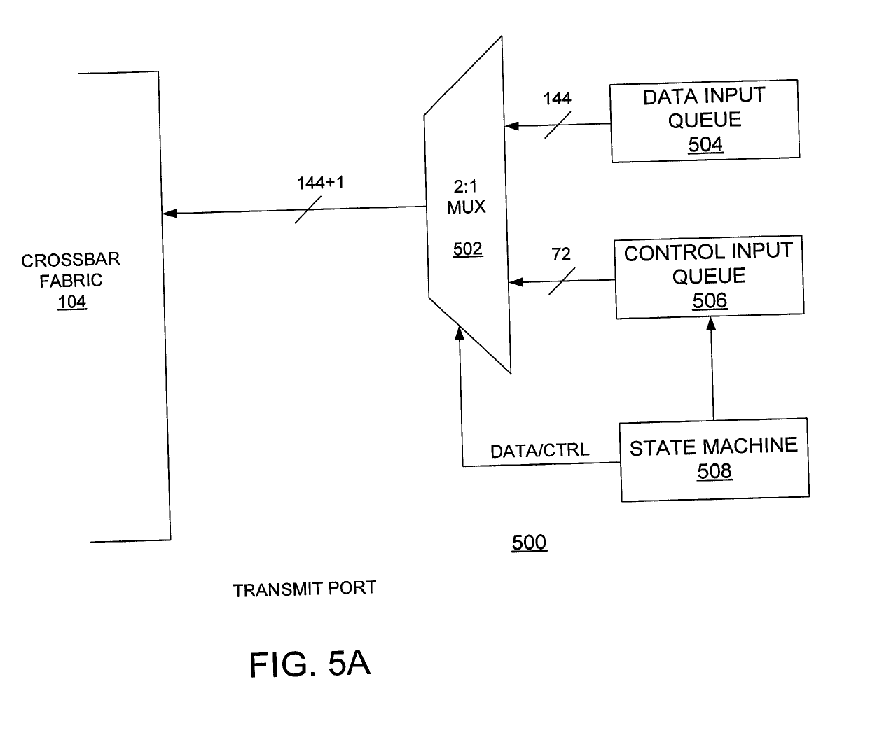

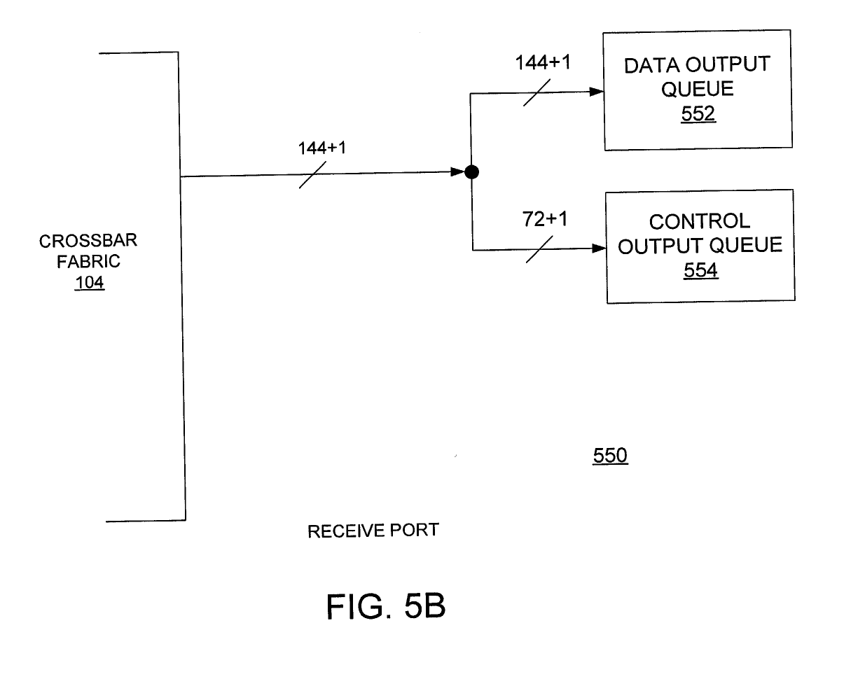

FIG. 5A depicts a transmit port 500 for a crossbar switch in accordance with an embodiment of the invention. As illustrated, the transmit port 500 may include, among other components, a multiplexer 502, a data input queue 504, a control input queue 506, and a state machine 508.

The data input queue 504 may comprise, for example, a first-in-first-out (FIFO) queue. The data input queue 504 is configured to receive data packets from the associated node to be transmitted from the transmit port 500 to the crossbar fabric 104. The control input queue 506 may also comprise, for example, a first-in-first-out (FIFO) queue. The control input queue 506 may be configured to receive control messages from the associated node to be transmitted from the transmit port 500 to the crossbar fabric 104.

Both the data input queue 504 and the control input queue 506 may output to the multiplexer (mux) 502. There may be, for example, 144 lines to transfer bits of the data packets in parallel from the data input queue 504 to the mux 502, and, for example, 72 lines to transfer bits of the control messages in parallel from the control input queue 506 to the mux 502. The mux 502 selects either the output of the data input queue 504 or of the control input queue 506 depending upon the state of the data/ctrl line that controls the mux 502. The mux 502 may be configured such that, if the data/ctri line is, for example, high, then it selects the output from the data input queue 504. Otherwise, if the data/ctrl line is low, then it may select the output from the control input queue 506. (Or vice-versa in a different configuration.) The state of the data/ctrl line bit may be controlled by a state machine 508. The state machine 508 would receive as input, among other inputs, the status of control messages, if any, in the control input queue 506.

In one embodiment, the mux 502 outputs its selection using 144+1=145 lines to the crossbar fabric. The extra (145^{th}) line may be configured to indicate whether the output comprises a data packet or a control message. For example, the extra line may be “1” if the output is a data packet and may be “0” if the output is a control message. If the output is a control message, only the lower (or upper) 72 lines may be used to transmit the control message information, while all 144 lines may be used to transmit data packet information.

FIG. 5B depicts a receive port 550 for a crossbar switch in accordance with an embodiment of the invention. As illustrated, the receive port 550 may include, among other components, a data output queue 552 and a control output queue 554. In one embodiment, for example, both queues 552 and 554 may be FIFO queues. Other embodiments may use other types of queues. For example, 144+1=145 lines may be output from the crossbar 104. The output from the crossbar 104 may be configured by way of a split to go to both the data output queue 552 and the control output queue 554. The data output queue 552 may receive all 144+1 lines, for example, while the control output queue 554 may receive only the lower 72 lines plus the extra (145^{th}) line. The extra line would indicate whether the output comprises a data packet or a control message. For example, the extra line may be “1” if the output is a data packet and may be “0” if the output is a control message. If it is a data packet (the extra line carries a 1), then the data output queue 552 may be configured to load data information from the 144 lines. If it is a control message (the extra line carries a 0), then the control output queue 554 may be configured to load control message from the 72 lower lines.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A method of switching by a crossbar switch having a plurality of ports, the method comprising:
transmitting data from a transmit port to a first receive port across the crossbar switch;
receiving a control message at the transmit port to be sent to a second receive port;
suspending the data transmission from the transmit port to the first receive port;
transmitting the control message from the transmit port to the second receive port; and
resuming the data transmission from the transmit port to the first receive port.

2. The method of claim 1, further comprising a signal transition to exit a data transfer mode and enter a data suspension mode that initiates suspending the data transmission.

3. The method of claim 2, further comprising a reverse signal transition to exit the data suspension mode and resume the data transmission by re-entering the data transfer mode.

4. The method of claim 1, wherein the data comprises data packets.

5. The method of claim 4, wherein the control message comprises a message from a group of messages that includes at least a request message, an acknowledgment message, and a no-acknowledgment message.

6. The method of claim 3, wherein the signal transition is applied to a multiplexing device that subsequently selects the control message to be transmitted across the crossbar switch, and wherein the reverse signal transition is also applied to the multiplexing device that subsequently re-selects the data to resume the data transmission.

7. The method of claim 3, wherein exiting the data transfer mode is accomplished by re-setting (or setting) a header bit, and wherein re-entering the data transfer mode is accomplished by setting (or re-setting) the header bit.

8. A crossbar switching system, the system comprising:
a crossbar switch having a plurality of transmit and receive ports;
transmit circuitry at a transmit port for providing a data transfer mode and a data suspension mode,
wherein data packets may be sent from the transmit port to a first receive port across the crossbar switch, and
wherein control messages may be sent from the transmit port to a second receive port across the crossbar switch.

9. The system of claim 8, wherein the transmit circuitry comprises a transmission multiplexer for selecting the data packets in the data transfer mode and for selecting the control messages in the data suspension mode.

10. The system of claim 9, wherein the transmit circuitry further comprises:
a data input queue for the data packets to be transmitted by the transmit port to the crossbar switch; and
a control input queue for the control messages to be transmitted by the transmit port to the crossbar switch,
wherein the data input queue and the control input queue are both coupled to the transmission multiplexer as inputs thereto.

11. The system of claim 10, further comprising:
receive circuitry at a receive port configured to receive data packets into a data output queue and to receive control messages into a control output queue.

12. The system of claim 11, wherein the receive circuitry further comprises a bit line coupled to the data output queue and to the control output queue, wherein the bit line indicates whether data packets or control messages are received.

13. The system of claim 8, wherein the control messages comprise higher priority packets than the data packets, and wherein the data suspension mode is entered when at least one control message is pending in a control input queue at the transmit port.

14. The system of claim 13, wherein the data transfer mode is re-entered when there are no more control messages pending in the control input queue at the transmit port.

15. The system of claim 8, wherein the control messages include at least a request message, an acknowledgement message, and a no-acknowledgement message.

16. The system of claim 9, wherein a signal transition causes entry into the data suspension mode.

17. The system of claim 16, wherein a reverse signal transition causes exit from the data suspension mode and re-entry into the data transfer mode.

18. The system of claim 17, wherein the signal transition is applied to the transmission multiplexer that subsequently selects the control messages to be transmitted across the crossbar switch.

19. The system of claim 18, wherein the reverse signal transition is also applied to the transmission multiplexer that subsequently re-selects the data packets to be transmitted across the crossbar switch.

20. An apparatus for switching data packets and control messages, the apparatus comprising:
means for transmitting data from a transmit port to a first receive port across a crossbar switch having a plurality of ports;
means for receiving a control message at the transmit port to be sent to a second receive port;
means for suspending the data transmission from the transmit port to the first receive port;
means for transmitting the control message from the transmit port to the second receive port; and
means for resuming the data transmission from the transmit port to the first receive port.
